(19) United States
(12) Patent Application Publication
(10) Pub. No.: US 2019/0304642 A1
(43) Pub. Date: Oct. 3, 2019

(54) FERRITE SINTERED MAGNET AND METHOD FOR MANUFACTURING THE SAME

(71) Applicant: TDK Corporation, Tokyo (JP)

(72) Inventors: Masanori IKEDA, Tokyo (JP); Hiroyuki MORITA, Tokyo (JP); Yoshitaka MURAKAWA, Tokyo (JP); Taku MURASE, Tokyo (JP)

(73) Assignee: TDK Corporation, Tokyo (JP)

(21) Appl. No.: 16/269,612

(22) Filed: Feb. 7, 2019

(30) Foreign Application Priority Data
Mar. 28, 2018 (JP) 2018-062769

(51) Int. Cl. H01F 1/11; H01F 41/02; C22C 38/10; C22C 38/00; B22F 9/04; B22F 3/16

(52) U.S. Cl. CPC H01F 1/11; H01F 41/0266; C22C 38/10; C22C 2202/02; B22F 9/04; B22F 3/16; B22F 2301/355; C22C 38/005

(57) ABSTRACT

A ferrite sintered magnet comprising ferrite particles having a hexagonal structure is provided. The ferrite sintered magnet comprises metallic elements at an atomic ratio represented by formula (1). In formula (1), R is at least one element selected from the group consisting of rare-earth elements and Bi, and comprises at least La. In formula (1), w, x, z and m satisfy formulae (2) to (5). The above-mentioned ferrite sintered magnet comprises 0.037 to 0.181% by mass of B in terms of H₃BO₃.

Ca_{1-w-x}R_{w}SrₓFe_{z}Coₘ (1)

0.360≤w≤0.420 (2)

0.110≤x≤0.173 (3)

8.51≤z≤9.71 (4)

0.208≤m≤0.269 (5)

### TECHNICAL FIELD

The present invention relates to a ferrite sintered magnet and a method for manufacturing the same.

### BACKGROUND

A hexagonal M type (magnetoplumbite type) Sr ferrite or Ba ferrite is known as a raw material of permanent magnets made of oxides. Ferrite magnets made of these ferrites are presented as permanent magnets in the form of ferrite sintered magnets or bonded magnets. With the downsizing of electronic components and enhancement in their performance in recent years, ferrite magnets are also being required to have high magnetic properties in spite of the small size thereof.

As indices of magnetic properties of permanent magnets, residual magnetic flux density (Br) and coercive force (HcJ) are generally used, and it is estimated that as they become higher, permanent magnets have higher magnetic properties. Until now, from the viewpoint of improving the Br and the HcJ of permanent magnets, examination has been performed by changing the composition, such as by incorporating specific elements into ferrite magnets.

For example, in Patent Literature 1, an oxide magnetic material and a sintered magnet which enable the Br and the HcJ to improve by incorporating at least La and Co in an M type Ca ferrite are disclosed.

[Patent Literature 1] Japanese Unexamined Patent Publication No. 2006-104050

### SUMMARY

As mentioned above, there have been various attempts of changing combinations of elements added to the main composition in order to obtain both Br and HcJ satisfactorily, but it has not been revealed yet what combinations of additional elements give high properties.

Moreover, even though the compositions are the same, the calcination temperature may affect the magnetic properties of magnets greatly. Therefore, the management width of calcination temperature may have to be narrowed to obtain stable magnetic properties in light of steps of manufacturing magnets, which makes manufacturing management difficult.

The present invention has been completed in light of the above-mentioned circumstances, and an object thereof is to provide a ferrite sintered magnet which has only a small dependence on calcination temperature and enables obtaining excellent magnetic properties stably and a method for manufacturing the same.

The present invention provides a ferrite sintered magnet comprising a ferrite having a hexagonal structure, wherein the above-mentioned ferrite sintered magnet comprises metallic elements at an atomic ratio represented by formula (1):

Ca_{1-w-x}R_{w}SrₓFe_{z}Coₘ (1)

in formula (1), R is at least one element selected from the group consisting of rare-earth elements and Bi, and comprises at least La, in formula (1), w, x, z and m satisfy formulae (2) to (5):

0.360≤w≤0.420 (2)

0.110≤x≤0.173 (3)

8.51≤z≤9.71 (4)

0.208≤m≤0.269 (5) and

the above-mentioned ferrite sintered magnet comprises 0.037 to 0.181% by mass of B in terms of H₃BO₃. The above-mentioned ferrite sintered magnet has only a small dependence on calcination temperature and stable magnetic properties.

It is preferable that the above-mentioned ferrite sintered magnet further comprise 0.03 to 0.3% by mass of Al in terms of Al₂O₃. The HcJ can be further improved by incorporating Al into the ferrite sintered magnet in the above-mentioned range.

The above-mentioned ferrite sintered magnet may further comprise 0.001 to 0.068% by mass of Ba in terms of BaO. Even though the ferrite sintered magnet comprises Ba in the above-mentioned range, the HcJ of the ferrite sintered magnet can be maintained at a high value. However, when it comprises more than 0.068% by mass of Ba in terms of BaO, the sintering temperature dependence tends to decrease, and the coercive force also tends to decrease.

The present invention further provides a method for manufacturing the above-mentioned ferrite sintered magnet, comprising: a step of preparing a raw material powder comprising Ca, R, Sr, Fe, Co and B; a step of calcining the above-mentioned raw material powder to obtain a calcined body; a step of pulverizing the above-mentioned calcined body to obtain a pulverized material; a step of molding the above-mentioned pulverized material to obtain a green compact; and a step of firing the above-mentioned green compact to obtain a ferrite sintered magnet. According to the method for manufacturing the above-mentioned ferrite sintered magnet, a ferrite sintered magnet excellent in magnetic properties is easily obtained, and the dependence of magnetic properties on calcination temperature can be further reduced.

The present invention further provides a method for manufacturing the above-mentioned ferrite sintered magnet, comprising: a step of preparation a raw material powder comprising Ca, R, Sr, Fe, Co, B and Al; a step of calcining the above-mentioned raw material powder to obtain a calcined body; a step of pulverizing the above-mentioned calcined body to obtain a pulverized material; a step of molding the above-mentioned pulverized material to obtain a green compact; and a step of firing the above-mentioned green compact to obtain a ferrite sintered magnet. According to the method for manufacturing the above-mentioned ferrite sintered magnet, a ferrite sintered magnet excellent in magnetic properties is easily obtained, and the dependence of magnetic properties on calcination temperature can be further reduced. Additionally, grain growth in calcination can be suppressed, and the size of the primary particles of the calcined body can be reduced. Consequently, the HcJ of the obtained ferrite sintered magnet can be further improved.

According to the present invention, a ferrite sintered magnet which has only a small dependence on calcination temperature and enables obtaining stable magnetic properties and a method for manufacturing the same can be provided.

### DETAILED DESCRIPTION

Suitable embodiments of the present invention will be described hereinafter. However, the present invention is not limited to the following embodiments.

(Ferrite Sintered Magnet)

A ferrite sintered magnet according to the present embodiment comprises ferrite particles (grains) which have a hexagonal structure. It is preferable that the above-mentioned ferrite be a magnetoplumbite type ferrite (M type ferrite).

The ferrite sintered magnet according to the present embodiment is an oxide comprising metallic elements at an atomic ratio represented by formula (1).

Ca_{1-w-x}R_{w}SrₓFe_{z}Coₘ (1)

In formula (1), R is at least one element selected from the group consisting of rare-earth elements (including Y) and Bi, and comprises at least La.

Additionally, in formula (1), w, x, z and m satisfy formulae (2) to (5). Since the w, the x, the z and the m satisfy formulae (2) to (5), the ferrite sintered magnet can have stable excellent residual magnetic flux density Br and coercive force HcJ.

0.360≤w≤0.420 (2)

0.110≤x≤0.173 (3)

8.51≤z≤9.71 (4)

0.208≤m≤0.269 (5)

0.110≤x≤0.173 (3)

8.51≤z≤9.71 (4)

0.208≤m≤0.269 (5)

The ferrite sintered magnet according to the present embodiment comprises B (boron) as a component other than the above-mentioned metallic elements. The content of B in the ferrite sintered magnet is 0.037 to 0.181% by mass in terms of H₃BO₃.

The composition of the ferrite sintered magnet according to the present embodiment will be described more specifically hereinafter.

It is preferable that the coefficient (1-w-x) of Ca at the atomic ratio of the metallic elements in the ferrite sintered magnet according to the present embodiment be more than 0.435 and less than 0.500. When the coefficient (1-w-x) of Ca is more than 0.435, a ferrite is easily formed into an M type ferrite. The ratios of nonmagnetic phases such as α-Fe₂O₃ are not only reduced, but R tends to be able to suppress the production of nonmagnetic different phases such as orthoferrite by allowing R to be surplus, and suppress deterioration in magnetic properties (especially Br or HcJ). It is more preferable that the coefficient (1-w-x) of Ca be 0.436 or more, and it is still more preferable that it be more than 0.445 from the same viewpoint.

Meanwhile, when the coefficient (1-w-x) of Ca is less than 0.500, a ferrite is not only easily formed into an M type ferrite, but non-magnetic phases such as CaFeO₃₋ₓ are reduced, and excellent magnetic properties are easily obtained. It is more preferable that the coefficient (1-w-x) of Ca be 0.491 or less from the same viewpoint.

R at the atomic ratio of the metallic elements in the ferrite sintered magnet according to the present embodiment is at least one element selected from the group consisting of rare-earth elements and Bi, and comprises at least La. Examples of the rare-earth elements include La, Ce, Pr, Nd, Sm, Eu, Gd, Tb, Dy, Ho, Er, Tm, Yb, Lu and Y. It is preferable that the R be La. The anisotropic magnetic field can be improved when the R is La.

The coefficient (w) of the R at the atomic ratio of the metallic elements in the ferrite sintered magnet according to the present embodiment is 0.360 or more and 0.420 or less. When the coefficient (w) of the R is in the above-mentioned range, favorable Br, HcJ and squareness ratio, Hk/HcJ, can be obtained. When the coefficient (w) of the R is 0.360 or more, the solid solution amount of Co in the ferrite sintered magnet is enough, and decreases in Br and HcJ can be suppressed. It is preferable the coefficient (w) of the R be more than 0.370, and it is more preferable that it be 0.380 or more from the same viewpoint. Meanwhile, when the coefficient (w) of the R is 0.420 or less, the production of nonmagnetic different phases such as orthoferrite can be suppressed, and the ferrite sintered magnet can be made a practical one, the HcJ of which is high. It is preferable that the coefficient (w) of the R be less than 0.410 from the same viewpoint.

The coefficient (x) of Sr at the atomic ratio of the metallic elements in the ferrite sintered magnet according to the present embodiment are 0.110 or more and 0.173 or less. When the coefficient (x) of Sr is in the above-mentioned range, favorable Br, HcJ and Hk/HcJ can be obtained. When the coefficient (x) of Sr is 0.110 or more, the ratio of Ca and/or La reduces, and a decrease in HcJ can be suppressed. Meanwhile, when the coefficient (x) of Sr is 0.173 or less, sufficient Br and HcJ are easily obtained. It is preferable that the coefficient (x) of Sr be less than 0.170, and it is more preferable that it be less than 0.165 from the same viewpoint.

The coefficient (z) of Fe at the atomic ratio of the metallic elements in the ferrite sintered magnet according to the present embodiment is 8.51 or more and 9.71 or less. Since the coefficient (z) of Fe is in the above-mentioned range, favorable Br, HcJ and Hk/HcJ can be obtained. It is preferable that the coefficient (z) of Fe be more than 8.70 and less than 9.40 from the viewpoint of obtaining more favorable HcJ. It is preferable that the coefficient (z) of Fe be more than 8.90 and less than 9.20 from the viewpoint of obtaining more favorable Hk/HcJ.

The coefficient (m) of Co at the atomic ratio of the metallic elements in the ferrite sintered magnet according to the present embodiment is 0.208 or more and 0.269 or less. When the coefficient (m) of Co is 0.208 or more, more excellent HcJ can be obtained. It is preferable that the coefficient (m) of Co be more than 0.210, it is more preferable that it be more than 0.220, and it is still more preferable that it be 0.250 or more from the same viewpoint. Meanwhile, when the coefficient (m) of Co is 0.269 or less, more excellent Br can be obtained. It is preferable that the coefficient (m) of Co be 0.250 or less from the same viewpoint. The anisotropic magnetic field can be improved by incorporating Co into the ferrite sintered magnet.

The ferrite sintered magnet according to the present embodiment comprises B (boron). The content of B in the ferrite sintered magnet is 0.037% by mass or more and 0.181% by mass or less in terms of H₃BO₃. The dependence of HcJ on calcination temperature can be reduced by incorporating B into the ferrite sintered magnet at 0.037% by mass or more in terms of H₃BO₃. It is preferable that the content of B be 0.050% by mass or more, and it is more preferable that it be 0.070% by mass or more in terms of H₃BO₃ from the same viewpoint. Meanwhile, high HcJ can be maintained by adjusting the content of B in the ferrite sintered magnet to 0.181% by mass or less in tent's of H₃BO₃. It is preferable that the content of B be 0.165% by mass or less, and it is more preferable that it be 0.150% by mass or less in terms of H₃BO₃ from the same viewpoint.

It is preferable that the ferrite sintered magnet according to the present embodiment further comprise Al (aluminum). It is preferable that the content of Al in a ferrite sintered magnet be 0.03% by mass or more and 0.3% by mass or less in terms of Al₂O₃. The grain growth at the time of calcination is suppressed, and the obtained coercive force of the ferrite sintered magnet is further improved by incorporating 0.03% by mass or more of Al into the ferrite sintered magnet in terms of Al₂O₃. It is preferable that the content of Al be 0.10% by mass or more in terms of Al₂O₃ from the same viewpoint.

Meanwhile, excellent Br and HcJ can be obtained by adjusting the content of Al in the ferrite sintered magnet to 0.3% by mass or less in terms of Al₂O₃.

The ferrite sintered magnet according to the present embodiment can further comprise Si (silicon). The content of Si in the ferrite sintered magnet can be 0.1 to 3% by mass in terms of SiO₂. High HcJ is easily obtained by incorporating Si into the ferrite sintered magnet in the above-mentioned range. The content of Si may be 0.5 to 1.0% by mass in terms of SiO₂ from the same viewpoint.

The ferrite sintered magnet according to the present embodiment may further comprise Ba (barium). When the ferrite sintered magnet comprises Ba, the content of Ba in the ferrite sintered magnet can be 0.001 to 0.068% by mass in terms of BaO. Even though the ferrite sintered magnet comprises Ba in the above-mentioned range, the HcJ of the ferrite sintered magnet can be maintained at a high value. However, when it comprises Ba at more than 0.068% by mass in terms of BaO, the sintering temperature dependence tends to decrease, and the coercive force also tends to decrease.

The ferrite sintered magnet according to the present embodiment may further comprise Cr, Ga, Mg, Cu, Mn, Ni, Zn, In, Li, Ti, Zr, Ge, Sn, V, Nb, Ta, Sb, As, W, Mo and the like. It is preferable that the content of each element be 3% by mass or less, and it is still more preferable that it be 1% by mass or less in terms of an oxide. It is preferable that the total content of these elements be 2% by mass or less from the viewpoint of avoiding deterioration in magnetic properties.

It is preferable that the ferrite sintered magnet according to the present embodiment do not comprise alkali metal elements (Na, K, Rb and the like). Alkali metal elements tend to reduce the saturation magnetization of the ferrite sintered magnet easily. However, for example, alkali metal elements may be included in raw materials for obtaining a ferrite sintered magnet, and as long as the amounts thereof are such amounts as to be included inevitably, they may be included in the ferrite sintered magnet. The content of alkali metal elements which does not influence magnetic properties greatly is 3% by mass or less.

The composition of the ferrite sintered magnet can be measured by fluorescence X-rays quantitative analysis. The existence of the main phase can be confirmed by X-ray diffraction or electron diffraction.

The average size of grains in the ferrite sintered magnet according to the present embodiment is preferably 1.5 μm or less, more preferably 1.0 μm or less, and still more preferably 0.5 to 1.0 μm. They have such an average grain size, and high HcJ is easily obtained thereby. The grain size of the ferrite sintered magnet can be measured with a scanning electron microscope.

(Method for Manufacturing Ferrite Sintered Magnet)

An example of a method for manufacturing a ferrite sintered magnet according to the present embodiment will be shown hereinafter.

The above-mentioned manufacturing method comprises a raw material powder preparation step, a calcination step, a pulverization step, a molding step and a firing step. The above-mentioned manufacturing method may comprise a finely pulverized slurry drying step and a kneading step between the above-mentioned pulverization step and the above-mentioned molding step, and may comprise a degreasing step between the above-mentioned molding step and the above-mentioned firing step. Steps will be described hereinafter.

<Raw Material Powder Preparation Step>

In the raw material powder preparation step, the raw materials of a ferrite sintered magnet are mixed to obtain a raw material mixture, and raw material powder is obtained by pulverizing this if needed. First, examples of the raw materials of the ferrite sintered magnet include compounds (raw material compounds) comprising one or two or more of the elements constituting the magnet. It is suitable that raw material compounds are, for example, powdered. Examples of the raw materials compounds include oxides of the elements and compounds which turn into oxides by firing (carbonates, hydroxides, nitrates or the like). Examples thereof include SrCO₃, La₂O₃, Fe₂O₃, BaCO₃, CaCO₃, Co₃O₄, H₃BO₃, Al₂O₃ and SiO₂.

Raw materials are weighed, for example, so that the composition of a desired ferrite sintered magnet is obtained, and mixed; and then mixed and pulverized using a wet attritor or a ball mill around 0.1 to 20 hours. It is preferable that the average particle size of the powder of the raw material compounds be around 0.1 to 5.0 μm, for example, from the viewpoint of enabling uniform blending. The raw material powder comprises at least Ca, R, Sr, Fe, Co and B. The dependence of the magnetic properties of the ferrite sintered magnet on calcination temperature can be further reduced especially by incorporating B into the raw material powder. When the ferrite sintered magnet comprises Al, the raw material powder further comprises Al. Therefore, the grain growth in calcination can be suppressed, and the primary particle size of a calcined body can be reduced.

Some of the raw materials can be also added in the below-mentioned pulverization step. However, it is preferable that none of the raw materials be added in the pulverization step in the present embodiment. That is, it is preferable that all of Ca, R, Sr, Fe, Co and B constituting the obtained ferrite sintered magnet (except elements mixed inevitably) be supplied from the raw material powder in the raw material powder preparation step. It is preferable especially that all of B constituting the ferrite sintered magnet be supplied from the raw material powder in the raw material powder preparation step. It is preferable that all of Al constituting the ferrite sintered magnet be supplied from the raw material powder in the raw material powder preparation step. Therefore, the above-mentioned effects by incorporating B or Al into the raw material powder is more easily obtained.

<Calcination Step>

In the calcination step, the raw material powder obtained in the raw material powder preparation step is calcined. It is preferable that calcination be performed in an oxidizing atmosphere such as the air (atmosphere). It is preferable that the calcination temperature be in the temperature range of 1100 to 1400° C., it is more preferable that it be 1100 to 1300° C., and it is still more preferable that it be 1150 to 1300° C. In the method for manufacturing a ferrite sintered magnet according to the present embodiment, stable magnetic properties can be obtained even at any of the above-mentioned calcination temperatures. The calcination time (time for which it is maintained at the calcination temperature) can be 1 second to 10 hours, and it is preferable that it be 1 second to 5 hours. A calcined body obtained by calcination comprises the main phase (M phase) as mentioned above at 70% or more. The primary particle size of the calcined body is preferably 5 μm or less, more preferably 2 μm or less, and still more preferably 1 μm or less. The HcJ of the obtained ferrite sintered magnet can be further improved by suppressing grain growth in calcination and reducing the primary particle size of the calcined body (for example, to 1 μm or less).

<Pulverization Step>

In the pulverization step, the calcined body which has become granular or massive at the calcination step is pulverized and powdered again. Therefore, molding in the below-mentioned molding step is performed easily. In this pulverization step, raw materials which are not mixed in the raw material powder preparation step may be further added. However, it is preferable that all the raw materials be mixed in the raw material powder preparation step from the viewpoint of obtaining the effect of calcination temperature dependence or the effect of suppressing grain growth in calcination. The pulverization step may have two steps of pulverizing the calcined body into coarse powder (coarse pulverization) and then pulverizing this still finer (fine pulverization).

Coarse pulverization is performed to an average particle size of 0.5 to 5.0 μm, for example, using a vibrating mill or the like. In the fine pulverization, the coarsely pulverized material obtained by coarse pulverization is further pulverized by a wet attritor, a ball mill, a jet mill or the like. In fine pulverization, fine pulverization is performed so that the average particle size of the obtained finely pulverized material is preferably around 0.08 to 2.0 μm, more preferably around 0.1 to 1.0 and still more preferably around 0.1 to 0.5 μm. It is preferable that the specific surface area of the finely pulverized material (determined, for example, by the BET method) be around 4 to 12 m²/g. Suitable pulverization time varies according to the pulverization method, and, for example, it is preferable that it be around 30 minutes to 20 hours in the case of a wet attritor and that it be around 10 to 50 hours in wet milling by a ball mill

In the fine pulverization step, a nonaqueous dispersion medium such as toluene or xylene can be used besides water as a dispersion medium in the case of a wet method. When a nonaqueous dispersion medium is used, high orientation tends to be obtained at the time of the below-mentioned wet molding. Meanwhile, when an aqueous dispersion medium is used, it is advantageous from the viewpoint of productivity.

In the fine pulverization step, for example, a polyhydric alcohol represented by the formula Cₙ(OH)ₙHₙ₊₂ may be added as a dispersant to increase the orientation degree of the sintered body obtained after firing. As the polyhydric alcohol, it is preferable that the n be 4 to 100, it is more preferable that it be 4 to 30, it is still more preferable that it be 4 to 20, and it is particularly preferable that it be 4 to 12 in the formula. Examples of the polyhydric alcohol include sorbitol. Two or more polyhydric alcohols may be used in combination. In addition to the polyhydric alcohol, other well-known dispersants may be further used in combination.

When the polyhydric alcohol is added, it is preferable that the amount thereof added be 0.05 to 5.0% by mass, it is more preferable that it be 0.1 to 3.0% by mass, and it is still more preferable that it be 0.2 to 2.0% by mass on the basis of an object to which it is added (for example, the coarsely pulverized material). The polyhydric alcohol added in the fine pulverization step is removed by thermal decomposition in the below-mentioned firing step.

<Molding Step>

In the molding step, the pulverized material (preferably finely pulverized material) obtained after the pulverization step is molded in a magnetic field to obtain a green compact. Molding can be performed by either method of dry molding and wet molding. It is preferable to perform wet molding from the viewpoint of increasing the degree of magnetic orientation.

When molding is performed by wet molding, it is preferable, for example, to obtain slurry by performing the above-mentioned fine pulverization step by a wet process, then concentrate this slurry to a predetermined concentration to obtain slurry for wet molding, and perform molding using this. Concentration of slurry can be performed by centrifugal separation, a filter press or the like. It is preferable that finely pulverized material represent around 30 to 80% by mass of the total amount of the slurry for wet molding. In this case, a surfactant such as gluconic acid, gluconate or sorbitol may be added to the slurry. A nonaqueous dispersion medium may be used as the dispersion medium. As the nonaqueous dispersion medium, organic dispersion medium such as toluene and xylene can be used. In this case, it is preferable to add a surfactant such as oleic acid. The slurry for wet molding may be prepared by adding a dispersion medium and the like to dry finely pulverized material after fine pulverization.

In the wet molding, this slurry for wet molding is next molding in a magnetic field. In that case, it is preferable that molding pressure be around 9.8 to 49 MPa (0.1 to 0.5 ton/cm²), and it is preferable that the magnetic field to apply be around 398 to 1194 kA/m (5 to 15 kOe).

<Firing Step>

In the firing step, the green compact obtained in the molding step is fired into a sintered body. Therefore, a sintered body of the ferrite magnet as mentioned above, namely a ferrite sintered magnet, is obtained. Firing can be performed in an oxidizing atmosphere such as the air atmosphere. It is preferable that firing temperature be 1050 to 1270° C., and it is more preferable that it be 1080 to 1240° C. It is preferable that firing time be around 0.5 to 3 hours.

When the green compact is obtained by the wet molding as mentioned above, rapidly heating this green compact without full drying may volatilize the dispersion medium and the like extremely and crack the green compact. Then, it is preferable to suppress the occurrence of a crack, for example, by heating the green compact at a low rate of temperature increase of around 1° C./minute from room temperature to around 100° C. and fully drying it before it reaches the above-mentioned sintering temperature from the viewpoint of avoiding such inconvenience. Additionally, when a surfactant (dispersant) and the like are added, it is preferable to fully remove them (degreasing treatment), for example, by heating the green compact at a rate of temperature increase of around 3° C./minute in the temperature range of around 100 to 500° C. These treatments may be performed at the start of the firing step, and may be performed before the firing step separately.

The suitable method for manufacturing a ferrite sintered magnet was described above; however, as long as the ferrite sintered magnet of the present invention is manufactured, the manufacturing method is not limited to the manufacturing method described above, and conditions can be changed properly.

The shape of the ferrite sintered magnet is not particularly limited. The ferrite sintered magnet may have a plate shape such as a disk shape, may have a pillar shape such a round column or a quadrangular prism, may have a shape such as a C shape, a bow shape and an arch shape, and may have a ring shape.

The ferrite sintered magnet according to the present embodiment can be used, for example, for rotating machines such as motors and dynamos, various sensors and the like.

### EXAMPLES

Although the present invention will be described still more specifically hereinafter, the present invention is not limited to the following Examples.

(Manufacturing of Ferrite Sintered Magnet)

### Example 1

<Raw Material Powder Preparation Step>

As raw materials of metallic elements constituting a ferrite sintered magnet, calcium carbonate (CaCO₃), lanthanum oxide (La₂O₃), strontium carbonate (SrCO₃), iron oxide (Fe₂O₃; comprising Mn, Cr, Al, Si, and Cl as impurities) and cobalt oxide (Co₃O₄) were provided. These raw materials were weighed so that w=0.390, x=0.140, z=9.05, and m=0.250 in the ferrite sintered magnet comprising metallic elements at an atomic ratio represented by formula (1a) and mixed. Subsequently, boric acid (H₃BO₃) and silicon oxide (SiO₂) were further provided as raw materials of the ferrite sintered magnet. Boric acid and silicon oxide were weighed so that the content of boron was 0.144% by mass in terms of H₃BO₃ and the content of silicon was 0.79% by mass in terms of SiO₂ on the basis of the whole obtained ferrite sintered magnet and added to the above-mentioned mixture. The obtained raw material mixture was mixed and pulverized in a wet attritor, and dried to obtain raw material powder.

Ca_{1-w-x}La_{w}SrₓFe_{z}Coₘ (1a)

<Calcination and Pulverization Steps>

The raw material powder was calcined in the air atmosphere at 1150° C. for 2 hours to obtain a calcined body. The obtained calcined body was coarsely pulverized with a small rod vibrating mill so that the specific surface area determined by the BET method was 0.5 to 2.5 m²/g. The obtained coarsely pulverized material was finely pulverized for 32 hours using a wet ball mill to obtain slurry for wet molding having finely pulverized particles wherein the specific surface area determined by the BET method was 7.0 to 10 m²/g. The slurry for wet molding was obtained by dehydrating the slurry after fine pulverization with a centrifuge, and adjusting the solid content concentration to 70 to 80% by mass.

<Molding and Firing Steps>

The slurry for wet molding was molded in an applied magnetic field of 10 kOe using a wet magnetic field molding machine to obtain a cylindrical green compact measuring 30 mm in diameter x 15 mm in thickness. The obtained green compact was fully dried in the air atmosphere at room temperature. Then, firing was performed in the air atmosphere at 1210° C. for 1 hour to obtain the ferrite sintered magnet of Example 1.

### Examples 2 to 3

The ferrite sintered magnets of Example 2 and Example 3 were obtained in the same way as in Example 1 except that the calcination temperature was changed to 1200° C. and 1250° C., respectively, in the calcination step.

### Example 4

The aluminum oxide (Al₂O₃) was further provided as the raw material of a metallic element constituting a ferrite sintered magnet. The ferrite sintered magnet of Example 4 was obtained in the same way as in Example 2 except that aluminum oxide was further weighed in addition to boric acid so that the content of aluminum was 0.05% by mass in terms of Al₂O₃ on the basis of the whole obtained ferrite sintered magnet, and these were added to the above-mentioned mixture in the raw material powder preparation step.

### Examples 5 to 8

The ferrite sintered magnets of Examples 5 to 8 were obtained in the same way as in Example 4 except that boric acid was weighed so that the content of boron was 0.037% by mass, 0.072% by mass, 0.109% by mass and 0.181% by mass, respectively, in terms of H₃BO₃ on the basis of the whole obtained ferrite sintered magnet and added to the above-mentioned mixture in the raw material powder preparation step.

### Examples 9 to 13

The ferrite sintered magnets of Examples 9 to 13 were obtained in the same way as in Example 4 except that aluminum oxide was weighed so that the content of aluminum was 0.03% by mass, 0.10% by mass, 0.20% by mass, 0.30% by mass and 0.40% by mass, respectively, in terms of Al₂O₃ on the basis of the whole obtained ferrite sintered magnet and added to the above-mentioned mixture in the raw material powder preparation step.

### Example 14

Barium oxide (BaO) was further provided as a raw material of a metallic element constituting a ferrite sintered magnet. The ferrite sintered magnet of Examples 14 was obtained in the same way as in Example 4 except that barium oxide was further weighed in addition to boric acid and aluminum oxide so that the content of barium was 0.013% by mass in terms of BaO on the basis of the whole obtained ferrite sintered magnet, and these were added to the above-mentioned mixture in the raw material powder preparation step.

### Examples 15 to 17

The ferrite sintered magnets of Examples 15 to 17 were obtained in the same way as in Example 14 except that barium oxide was weighed so that the content of barium was 0.026% by mass, 0.051% by mass and 0.068% by mass, respectively, in terms of BaO on the basis of the whole obtained ferrite sintered magnet and added to the above-mentioned mixture in the raw material powder preparation step.

### Comparative Example 1

The ferrite sintered magnet of Comparative Example 1 was obtained in the same way as in Example 1 except that boric acid was not added in the raw material powder preparation step.

### Comparative Examples 2 to 3

The ferrite sintered magnets of Comparative Example 2 and Comparative Example 3 were obtained in the same way as in Comparative Example 1 except that the calcination temperature was changed to 1200° C. and 1250° C., respectively, in the calcination step.

### Comparative Example 4

The ferrite sintered magnet of Comparative Example 4 was obtained in the same way as in Example 4 except that boric acid was not added in the raw material powder preparation step.

### Comparative Examples 5 to 6

The ferrite sintered magnets of Comparative Examples 5 to 6 were obtained in the same way as in Example 4 except that boric acid was weighed so that the content of boron was 0.215% by mass and 0.305% by mass, respectively, in terms of H₃BO₃ on the basis of the whole obtained ferrite sintered magnet and added to the above-mentioned mixture in the raw material powder preparation step.

### Examples 18 to 41 and Comparative Examples 7 to 14

The ferrite sintered magnets of Examples 18 to 41 and Comparative Examples 7 to 14 were obtained in the same way as in Example 4 except that raw materials were weighed so that w, x, z and m were as shown in Table 2 in the ferrite sintered magnet comprising metallic elements at an atomic ratio represented by formula (1a) and mixed in the raw material powder preparation step.

Ca_{1-w-x}La_{w}SrₓFe_{z}Coₘ (1a)

(Evaluation Method)

[Magnetic Properties]

The upper and lower sides of each cylindrical ferrite sintered magnet obtained by Examples and Comparative Examples were processed, then the residual magnetic flux densities Br (mT) and coercive forces HcJ (kA/m) thereof were determined, and external magnetic field intensities (Bk) when the magnetic flux densities were 90% of the Br were measured using a B-H tracer at a maximum applied magnetic field of 25 kOe. The squareness ratio Hk/HcJ was calculated from the measurement results of Hk and HcJ. The values of Br, HcJ and Hk/HcJ are shown in Tables 1 and 2.

[Calcination Temperature Dependence]

A ferrite sintered magnet was manufactured in the same way as in each of Examples and Comparative Examples except that the calcination temperature was 50° C. higher than that in each of Examples and Comparative Examples, and the coercive force HcJ was determined. ΔHcJ/AT was determined by dividing the difference in HcJ ΔHcJ made when the calcination temperature was changed by the difference in calcination temperature ΔT. The calcination temperature dependence of HcJ was evaluated according to the following standards. The evaluation results are shown in Tables 1 and 2. When the evaluation result was A, it was determined that the calcination temperature dependence was low.

A: The ΔHcJ/ΔT is less than 0.2.
B: The ΔHcJ/ΔT is 0.2 or more and less than 1.0.
C: The ΔHcJ/ΔT is 1.0 or more.

[Average Particle Size of Primary Particles After Calcination]

The surface of a calcined body after the calcination step was observed with a scanning electron microscope, the particle sizes of 100 primary particles were measured, and the average value thereof was calculated. The average particle size of the primary particles after calcination was evaluated according to the following standards. The evaluation results are shown in Table 1.

A: The average particle size of the primary particles after calcination is 1.0 μm or less.
B: The average particle size of the primary particles after calcination is more than 1.0 μm and 2.0 μm or less.
C: The average particle size of the primary particles after calcination is more than 2.0 μm.

TABLE 1

| | | | | | | | | | | Average |
|---|---|---|---|---|---|---|---|---|---|---|
| | | | | | | | | | | particle |
| | B | Al | Ba | | | | | Calcination | | size of |
| | content in | content in | content in | Calcina- | | | | temperature | | primary |
| | terms of | terms of | terms of | tion | | | | dependence | | particles |
| | H₃BO₃ | Al₂O₃ | BaO | temper- | | | | | Evalua- | after |
| | (% by | (% by | (% by | ature | Br | HcJ | Hk/HcJ | ΔHcJ/ | tion | calcina- |
| | mass) | mass) | mass) | (° C.) | (mT) | (kA/m) | (%) | ΔT | result | tion |
| Comparative | 0 | 0 | 0 | 1150 | 454.6 | 278.2 | 88.9 | 2.16 | C | C |
| Example 1 | | | | | | | | | | |
| Comparative | 0 | 0 | 0 | 1200 | 454.0 | 386.0 | 85.0 | 0.22 | B | C |
| Example 2 | | | | | | | | | | |
| Comparative | 0 | 0 | 0 | 1250 | 453.9 | 397.0 | 78.2 | 0.26 | B | C |
| Example 3 | | | | | | | | | | |
| Example 1 | 0.144 | 0 | 0 | 1150 | 459.6 | 407.2 | 87.3 | 0.02 | A | C |
| Example 2 | 0.144 | 0 | 0 | 1200 | 463.5 | 408.0 | 89.3 | 0.19 | A | C |
| Example 3 | 0.144 | 0 | 0 | 1250 | 461.5 | 417.3 | 91.1 | 0.16 | A | C |
| Comparative | 0 | 0.05 | 0 | 1200 | 452.0 | 397.0 | 79.0 | 0.24 | B | C |
| Example 4 | | | | | | | | | | |
| Example 5 | 0.037 | 0.05 | 0 | 1200 | 456.7 | 427.4 | 88.7 | 0.16 | A | A |
| Example 6 | 0.072 | 0.05 | 0 | 1200 | 461.5 | 441.7 | 89.6 | 0.15 | A | A |
| Example 7 | 0.109 | 0.05 | 0 | 1200 | 460.8 | 443.0 | 89.1 | 0.17 | A | A |
| Example 4 | 0.144 | 0.05 | 0 | 1200 | 457.6 | 414.4 | 89.3 | 0.16 | A | A |
| Example 8 | 0.181 | 0.05 | 0 | 1200 | 453.5 | 402.1 | 88.9 | 0.16 | A | A |
| Example 9 | 0.144 | 0.03 | 0 | 1200 | 459.9 | 412.7 | 88.1 | 0.16 | A | A |
| Example 10 | 0.144 | 0.10 | 0 | 1200 | 459.6 | 437.3 | 86.7 | 0.16 | A | A |
| Example 11 | 0.144 | 0.20 | 0 | 1200 | 456.7 | 437.6 | 88.9 | 0.14 | A | A |
| Example 12 | 0.144 | 0.30 | 0 | 1200 | 452.8 | 429.6 | 88.5 | 0.16 | A | A |
| Example 13 | 0.144 | 0.40 | 0 | 1200 | 449.0 | 399.0 | 88.7 | 0.16 | A | A |
| Example 14 | 0.144 | 0.05 | 0.013 | 1200 | 457.6 | 414.0 | 89.3 | 0.16 | A | A |
| Example 15 | 0.144 | 0.05 | 0.026 | 1200 | 457.5 | 413.6 | 89.3 | 0.17 | A | A |
| Example 16 | 0.144 | 0.05 | 0.051 | 1200 | 457.5 | 414.5 | 89.4 | 0.19 | A | A |
| Example 17 | 0.144 | 0.05 | 0.068 | 1200 | 457.1 | 402.0 | 89.2 | 0.19 | A | A |
| Comparative | 0.215 | 0.05 | 0 | 1200 | 445.9 | 393.3 | 88.0 | 0.18 | A | A |
| Example 5 | | | | | | | | | | |
| Comparative | 0.305 | 0.05 | 0 | 1200 | 443.0 | 371.1 | 87.9 | 0.19 | A | A |
| Example 6 | | | | | | | | | | |

TABLE 2

| | | | | | | B | Al | | | | Calcina- |
|---|---|---|---|---|---|---|---|---|---|---|---|
| | | | | | | content in | content in | | | | tion |
| | | | | | | terms of | terms of | | | | temper- |
| | Ca_{1-w-x}La_{w}SrₓFe_{z}Coₘ | | | | | H₃BO₃ | Al₂O₃ | | | | ature |
| | Ca | La | Sr | Fe | Co | (% by | (% by | Br | HcJ | Hk/HcJ | depend- |
| | 1-w-x | w | x | z | m | mass) | mass) | (mT) | (KA/m) | (%) | ence |
| Comparative | 0.432 | 0.390 | 0.178 | 9.12 | 0.239 | 0.144 | 0.05 | 455.9 | 395.1 | 89.3 | A |
| Example 7 | | | | | | | | | | | |
| Example 18 | 0.436 | 0.390 | 0.173 | 9.11 | 0.240 | 0.144 | 0.05 | 456.3 | 400.4 | 89.2 | A |
| Example 19 | 0.440 | 0.391 | 0.169 | 9.10 | 0.239 | 0.144 | 0.05 | 456.9 | 402.0 | 89.0 | A |
| Example 20 | 0.449 | 0.390 | 0.161 | 9.10 | 0.240 | 0.144 | 0.05 | 458.0 | 417.0 | 88.4 | A |
| Example 21 | 0.463 | 0.388 | 0.149 | 9.14 | 0.241 | 0.144 | 0.05 | 457.5 | 415.0 | 89.0 | A |
| Example 4 | 0.469 | 0.390 | 0.141 | 9.10 | 0.240 | 0.144 | 0.05 | 457.6 | 414.4 | 89.3 | A |
| Example 22 | 0.482 | 0.388 | 0.130 | 9.10 | 0.240 | 0.144 | 0.05 | 457.0 | 415.0 | 89.5 | A |
| Example 23 | 0.491 | 0.390 | 0.119 | 9.13 | 0.241 | 0.144 | 0.05 | 456.9 | 416.0 | 88.0 | A |
| Comparative | 0.501 | 0.392 | 0.107 | 9.10 | 0.240 | 0.144 | 0.05 | 456.0 | 397.5 | 89.3 | A |
| Example 8 | | | | | | | | | | | |
| Comparative | 0.470 | 0.353 | 0.177 | 9.10 | 0.240 | 0.144 | 0.05 | 442.0 | 396.0 | 89.0 | A |
| Example 9 | | | | | | | | | | | |
| Example 24 | 0.472 | 0.360 | 0.168 | 9.10 | 0.238 | 0.144 | 0.05 | 449.0 | 405.0 | 88.6 | A |
| Example 25 | 0.470 | 0.371 | 0.159 | 9.13 | 0.240 | 0.144 | 0.05 | 457.0 | 410.0 | 87.7 | A |
| Example 26 | 0.469 | 0.380 | 0.151 | 9.10 | 0.241 | 0.144 | 0.05 | 458.5 | 418.0 | 90.1 | A |
| Example 4 | 0.469 | 0.390 | 0.141 | 9.10 | 0.240 | 0.144 | 0.05 | 457.6 | 414.4 | 89.3 | A |
| Example 27 | 0.470 | 0.399 | 0.131 | 9.10 | 0.237 | 0.144 | 0.05 | 458.0 | 415.0 | 89.1 | A |
| Example 28 | 0.468 | 0.409 | 0.123 | 9.07 | 0.240 | 0.144 | 0.05 | 457.1 | 416.2 | 87.7 | A |
| Example 29 | 0.470 | 0.420 | 0.110 | 9.10 | 0.240 | 0.144 | 0.05 | 447.5 | 410.0 | 89.2 | A |
| Comparative | 0.471 | 0.430 | 0.099 | 9.10 | 0.240 | 0.144 | 0.05 | 444.4 | 403.0 | 88.0 | A |
| Example 10 | | | | | | | | | | | |
| Comparative | 0.472 | 0.388 | 0.140 | 8.32 | 0.238 | 0.144 | 0.05 | 446.7 | 390.7 | 80.2 | A |
| Example 11 | | | | | | | | | | | |
| Example 30 | 0.470 | 0.390 | 0.140 | 8.51 | 0.239 | 0.144 | 0.05 | 453.0 | 400.0 | 84.4 | A |
| Example 31 | 0.468 | 0.390 | 0.142 | 8.71 | 0.238 | 0.144 | 0.05 | 455.1 | 410.0 | 86.4 | A |
| Example 32 | 0.470 | 0.388 | 0.142 | 8.89 | 0.240 | 0.144 | 0.05 | 456.2 | 413.0 | 85.8 | A |
| Example 4 | 0.469 | 0.390 | 0.141 | 9.10 | 0.240 | 0.144 | 0.05 | 457.6 | 414.4 | 89.3 | A |
| Example 33 | 0.472 | 0.385 | 0.143 | 9.29 | 0.240 | 0.144 | 0.05 | 457.0 | 415.0 | 88.0 | A |
| Example 34 | 0.470 | 0.390 | 0.140 | 9.48 | 0.241 | 0.144 | 0.05 | 456.5 | 403.7 | 88.5 | A |
| Example 35 | 0.470 | 0.392 | 0.138 | 9.71 | 0.240 | 0.144 | 0.05 | 455.8 | 400.0 | 87.6 | A |
| Comparative | 0.471 | 0.390 | 0.139 | 9.90 | 0.241 | 0.144 | 0.05 | 455.0 | 385.0 | 86.1 | A |
| Example 12 | | | | | | | | | | | |
| Comparative | 0.470 | 0.389 | 0.141 | 9.10 | 0.200 | 0.144 | 0.05 | 448.0 | 386.0 | 89.6 | A |
| Example 13 | | | | | | | | | | | |
| Example 36 | 0.469 | 0.390 | 0.141 | 9.10 | 0.208 | 0.144 | 0.05 | 452.2 | 402.0 | 89.5 | A |
| Example 37 | 0.470 | 0.391 | 0.139 | 9.11 | 0.218 | 0.144 | 0.05 | 454.0 | 408.0 | 88.7 | A |
| Example 38 | 0.467 | 0.391 | 0.142 | 9.11 | 0.230 | 0.144 | 0.05 | 457.0 | 414.0 | 89.2 | A |
| Example 4 | 0.469 | 0.390 | 0.141 | 9.10 | 0.240 | 0.144 | 0.05 | 457.6 | 414.4 | 89.3 | A |
| Example 39 | 0.470 | 0.390 | 0.140 | 9.08 | 0.250 | 0.144 | 0.05 | 455.0 | 425.0 | 88.2 | A |
| Example 40 | 0.473 | 0387 | 0.140 | 9.10 | 0.257 | 0.144 | 0.05 | 453.1 | 432.3 | 87.7 | A |
| Example 41 | 0.470 | 0.390 | 0.140 | 9.07 | 0.269 | 0.144 | 0.05 | 454.0 | 440.0 | 84.2 | A |
| Comparative | 0.471 | 0.390 | 0.139 | 9.10 | 0.281 | 0.144 | 0.05 | 444.5 | 437.0 | 80.5 | A |
| Example 14 | | | | | | | | | | | |

As is apparent from the evaluation results of Examples 1 to 3 and Comparative Examples 1 to 3 in Table 1, it can be confirmed that the calcination temperature dependence of coercive forces HcJ was improved by adding boric acid in the manufacturing of ferrite sintered magnets. From the evaluation results of Example 2 and Example 4, it can be confirmed that the grain growth at the time of calcination is suppressed, and the average particle size of the primary particles after calcination can be suppressed to less than 1.0 μm by adding aluminum oxide in addition to boric acid in the manufacturing of ferrite sintered magnets. For this reason, the coercive force HcJ of a ferrite sintered magnet can be further improved.

As is apparent from Table 2, it can be further confirmed that high coercive force HcJ which is approximately 400 kA/m can be obtained stably independent of calcination temperature by incorporating Ca, La, Sr, Fe and Co into a ferrite sintered magnet in an extremely limited range.

What is claimed is:

1. A ferrite sintered magnet comprising ferrite particles having a hexagonal structure, wherein the ferrite sintered magnet comprises metallic elements at an atomic ratio represented by formula (1):
Ca_{1-w-x}R_{w}SrₓF e_{z}Coₘ (1)
in formula (1), R is at least one element selected from the group consisting of rare-earth elements and Bi, and comprises at least La, in formula (1), w, x, z and m satisfy formulae (2) to (5):
0.360≤w≤0.420 (2)
0.110≤x≤0.173 (3)
8.51≤z≤9.71 (4)
0.208≤m≤0.269 (5) and
the ferrite sintered magnet comprises 0.037 to 0.181% by mass of B in terms of H₃BO₃.

2. The ferrite sintered magnet according to claim 1, wherein the ferrite sintered magnet further comprises 0.03 to 0.3% by mass of Al in terms of Al₂O₃.

3. The ferrite sintered magnet according to claim 1, wherein the ferrite sintered magnet further comprises 0.001 to 0.068% by mass of Ba in terms of BaO.

4. A method for manufacturing the ferrite sintered magnet according to claim 1, comprising:
a step of preparation a raw material powder comprising Ca, R, Sr, Fe, Co and B;
a step of calcining the raw material powder to obtain a calcined body;
a step of pulverizing the calcined body to obtain a pulverized material;
a step of molding the pulverized material to obtain a green compact; and
a step of firing the green compact to obtain the ferrite sintered magnet.

5. A method for manufacturing the ferrite sintered magnet according to claim 2, comprising:
a step of preparation a raw material powder comprising Ca, R, Sr, Fe, Co, B and Al;
a step of calcining the raw material powder to obtain a calcined body;
a step of pulverizing the calcined body to obtain a pulverized material;
a step of molding the pulverized material to obtain a green compact; and
a step of firing the green compact to obtain the ferrite sintered magnet.
